(19) United States
(12) Patent Application Publication
(10) Pub. No.: US 2011/0188781 A1
(43) Pub. Date: Aug. 4, 2011

(54) Quick 3D-to-2D Points Matching Based on the Perspective Projection

(76) Inventor: Songxiang Gu, Hangzhou (CN)

(21) Appl. No.: 12/697,691

(22) Filed: Feb. 1, 2010

(51) Int. Cl. G06K 9/32

(52) U.S. Cl. 382/295

(57) ABSTRACT

This invention describes a quick 3D-to-2D point matching algorithm. The major contribution is to substitute a new O(2ⁿ) algorithm for the traditional N! method by introducing a convex hull based enumerator and projecting a 3D point set into a 2D plane yields a corresponding 2D point set. In some cases, matching information is lost during the projection. Therefore, to compute projection parameters, the recovery of the 3D-to-2D correspondence is important. Traditionally, an exhaustive enumerator permutes all the potential matching sets and a calibration computation is used to choose the lowest residual error computed parameters as “correct” one. Our enumerator shrinks the search space by computing the convex hull for both 2D and 3D points set, validating the potential matching cases with a horizon validation and, finally, applying recursive computation to further reduce the searching space.

### STATEMENT

This work was supported by the National Institute of Biomedical Imaging and Bioengineering for Grant R01-EB001457.

### CLAIMS

1. A method of finding correspondence between 3D uniform point set and its 2D perspective projection, comprising the steps of: convex hull computation for both 3D and 2D point sets; potential matching cases selection; calibration computation based validation.
2. The method of claim 1, wherein the step of potential matching cases selection comprises the steps of: potential 3D to 2D convex hull matching; horizon computation based validation; recursive potential matching case selection for next layer points.

### FIELD OF INVENTION

The present invention relates to a general solution for the global best matching between the uniform 3D points and their 2D perspective projections, in which the correspondence information is unknown.

### BACKGROUND

Nowadays, 3D-to-2D points matching is still an open topic in computer vision. Perspectively projecting a 3D point set into a 2D plane yields a corresponding 2D point set. If the points are identical, we will lose the correspondence information through the projection (Appendix A). On the other hand, if our input data is 3D and 2D point sets and we want to estimate the projection parameters based on the 3D and 2D points' coordinates, we have to know the point correspondence information. The traditional way to acquire the best matching 3D point set is to enumerate all potential matching cases via perspective projection calibration computation. A single matching case yields a set of projection parameters, which we use to project the 3D points into the 2D plane. We then calculate the residual errors, which we define as the difference between the projected 2D points and the input 2D points. We then choose the matching case with minimal residual error as the correct one. To recover a best matching correspondence without any constraint requires a search space of N! for N points. Therefore, the brute-force method have to make N! calibration computations for the best points matching.

The RANSAC algorithm is one of the most popular algorithms for 3D-to-2D points matching. The time complexity of the RANSAC algorithm is O(C(l, N)*l!), where N is the total point number and l is the point number of the selected subset (l is no less than 6). For example, given a set of 10 points, RANSAC algorithm takes around 151,200 calibration computations for the best matching. Though the time complexity of this solution if better than our method, our method consumes much less time when the point number is small.

Although calibration is not the main contribution of our work, it is an important component of this invention. Pin-hole camera model with 11 parameters is a close-form calibration model. Tsai introduced a calibration method to solve the pin-hole without distortion and skew. At least 6 points in both 3D and 2D space are required with only a single camera. Since we have the 3D and 2D point coordinates and only one camera, we employ Tsai's calibration method in our points matching algorithm.

### SUMMARY OF THE INVENTION

In this invention, we introduce a novel point matching algorithm to pick the correct match with O(2ⁿ) complexity as well as solve the perspective projection parameters with the following closed-form calibration method. We combine calibration with points matching computation as a whole to create an efficient algorithm for the global optimized matching case. To simplify the problem, we do not consider distortion. Although the total potential 3D-2D points matching cases are N!, most of the cases can be disregarded. Only the potential matching sets that follow the topology restrictions between 3D and 2D point sets are considered for the calibration computation.

To utilize the topology information and simplify the computation, we have to compute the convex hull for both 3D and 2D point sets. Since we assume no distortion, a 2D convex hull corresponds a circuit on the 3D convex hull (Appendix A). With such a theorem, the topology degenerates the factorial method to an exponential one. Secondly, we claim that not all the 3D circuits, but only 3D horizons can be projected into 2D plane as a convex hull ([0019]). Therefore, we propose a validation method to invalidate a large number of 3D circuits. Then, a recursive method is adopted to search the remaining points dynamically. After putting all the filtered matching cases into the calibration computation, we create a set of projection parameters. Residual errors are computed via the calculated projection parameters. Given a pair of 3D/2D point sets, the exact matching case and the correct projection parameters are finally picked out by the minimum residual error. The residual error is introduced to measure the validity of a potential matching case. For 3D point set S and 2D projection set S′, we have

$$E = 1 / n {\sum }_{i = 0}^{n - 1} ‖ {S}^{′} - Proj ( S , Calib ( \overline{S} , {S}^{′} ) ) ‖ \qquad ( 1 )$$

where n is the number of the points; S̅ is one of the potential matching cases; Proj( ) is the projection function with the parameters of 3D point set and projection parameters and Calib( ) means the calibration for the projection parameters. We want to try less times of S̅ to get the minimum residual error E.

### BRIEF DESCRIPTION OF THE DRAWINGS

The present invention will become more fully understood from the detailed description given herein below and the accompanying drawings, which are given by illustration only, and thus are not limitative of the present invention and wherein:

FIG. 1 conceptually shows the 3D convex hull and 2D convex hulls of different layers. (a) Convex hull of 3D point set S; (b) Convex hull of 2D point set S′.

FIG. 2 conceptually shows the valid region of potential focus points. (a) Valid Region for a convex edge. (b) Common Valid Region intersected by multiple valid regions.

FIG. 3 shows the recursive validation for the next layer points.

(a; b) m points circuit in 3D convex hull corresponding to m points in the 2D convex hull. (c; d) Next layer points matching

FIG. 4 compares the time consumption between the different methods. Comparison between different methods with multiple point numbers. (a) Comparison of average potential matching cases. (b) Comparison of average time consumption.

FIG. 5 illustrates 3D triangle projection.

FIG. 6 shows the connection between the 3D and 2D convex hull edges. Corresponding convex hull edge in (a) 3D and (b) 2D.

### DETAILED DESCRIPTION OF THE INVENTION

The present inventions now will be described more fully hereinafter with reference to the accompanying drawings, in which some examples of the inventions are shown.

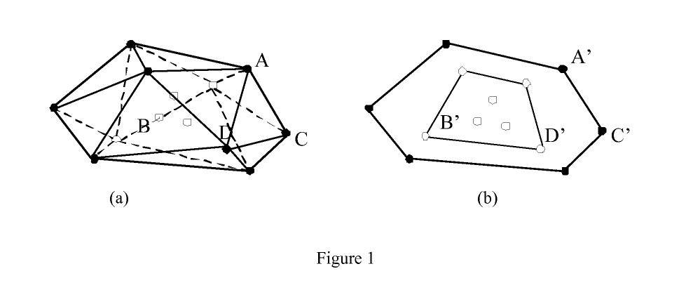

Though the 3D and 2D points are identical, there are still some topology information that we can use to shrink our searching space. To extract topology information, convex hulls are computed on both 3D and 2D point sets [FIG. 1]. A convex hull of a 3D point set S, is the unique convex polygon or polytope, which contains S and all of whose vertices are points from S.

Computing the convex hull is a well studied problem in computational geometry. Based on the convex hull, we have split all the points into two categories: boundary points, which are on the convex hull, and interior points, which are interior to the convex hull. For example, in the FIG. 1(a), the 3D point A and C are boundary points and the 3D point B is an interior point. In the FIG. 1(b), the 2D point A′ and C′ are boundary points and the 2D point B′ is an interior point.

Based on two primary theorems (Theorem 1, Theorem 2 in Appendix A) concerning 3D and 2D convex hulls, it is easy to prove that all the boundary points on the 2D convex hull correspond to a subset of the boundary points on the 3D convex hull. Furthermore, based on Theorem 3 (Appendix A), we can claim the circuit of 2D boundary points [FIG. 1(b)] must correspond to a circuit of 3D boundary points on 3D convex hull [FIG. 1(a)]. This means, to match the m-length 2D convex hull, we do not have to try all the permutations of the 3D point set, but only the m-length circuits on the 3D convex hull. With the insight from the topology, we shrink the searching space in the first step.

It is not difficult to trace a m-length circuit on the 3D convex hull. After tracing such a circuit, if the point number of 2D convex is m, we only need 2m trials to search for the correct matching case in the 3D and 2D boundary point sets. In other words, we need m trials to proceed clockwise around the 2D boundary point set and another m trials for the counter-clockwise case. We use the terminology Hₙ^{m} to denote the number of valid m-length circuits on an n-vertex convex hull.

Considering the constraint on convex hull point matching, we search for a m-length circuit on the 3D convex hull for the first matching step, instead of an exhaustive N! search. This first convex hull matching step reduces the computational complexity from O(N!) to O(2m Hₙ^{m}(N-m)!).

Another validation method based on the horizon computation is used to invalid more potential matching cases before calibration. If a 3D circuit could be projected into a 2D plane as a convex hull, all of the points and edges in that circuit should be visible to a certain focal point. Such a circuit is called horizon. In other words, if there is no such a 3D focal point that can view all the edges on the 3D circuit, the circuit is not a valid horizon and therefore can be excluded. Here we developed a horizon validation method to validate the circuits.

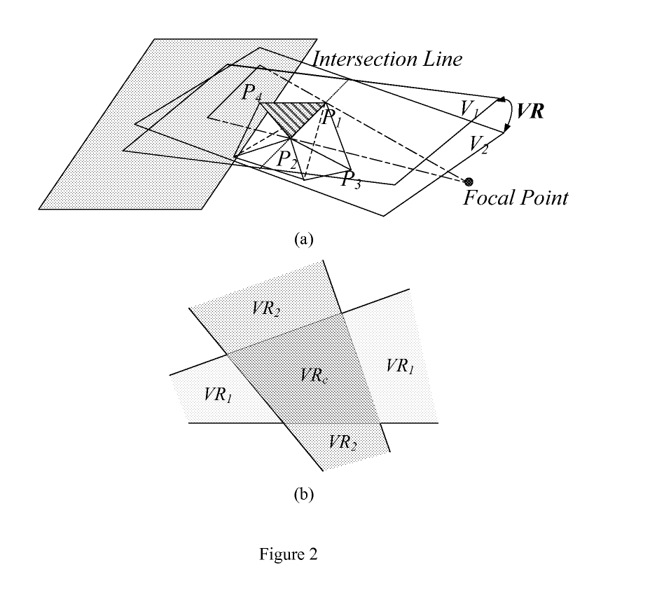

As shown in FIG. 2(a), for an edge P₁P₂ in the 3D circuit, there is always a pair of triangles ((ΔP₁P₂P₃), (ΔP₁P₂P₄)) associated with it. If the edge is projected into a 2D plane as a 2D convex edge, the focal point must view one of the pair of the triangles, but not both. Particularly, in FIG. 2(a), if the focal point is in the region between the planes V₁ and V₂, it can view the triangle (ΔP₁P₂P₄), but not (ΔP₁P₂P₃). Therefore, for each edge, there is a valid region in 3D space that the focal point could only exist in, which we call a valid region (VR). Each edge is determined by its own valid region VR. For two edges, there are two valid regions that can be intersected into a common valid region VR_{c} (FIG. 2(b)). If there is a focal point that can view these two edges, the focal point has to be in the common valid regions with VR_{c}≠null. In general, if all of the edges have at least one common valid region (VR_{c}=VR₁∩V R2 . . . ∩V R₁≠null, l is the edge number), the circuit is proved to be a horizon. Otherwise, if the common valid region is null, no matter where we put the focal point we can not view the circuit as a horizon. Therefore, we consider the circuit to be invalid. Though we have not analyzed the horizon validation mathematically, based on the results of our simulation shown in the Experiment Section, this algorithm is an improvement of approximately O(2ⁿ) over an exhaustive search.

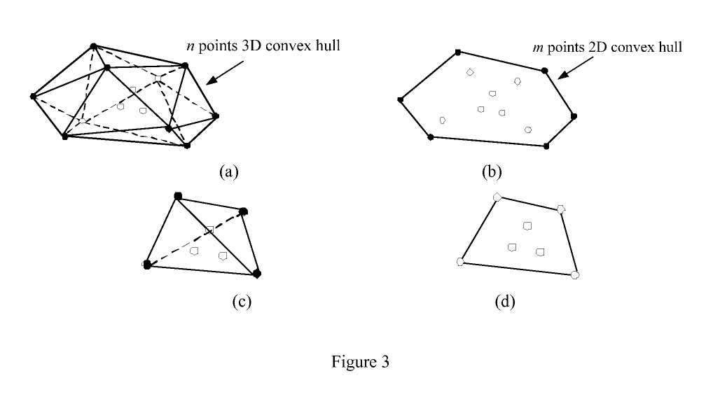

Though we only mentioned the validations for the convex hull, all the validation methods can be propagated to the remaining points after we have picked the first potential matching set of the convex hull points. As shown in FIG. 3(a; b), during the matching procedure, we dynamically split the point sets into m matched points and (N-m) remaining points in both 3D and 2D point sets by the circuit. Since the two (N-m) remaining point sets can be considered as a new independent potential matching set, we can be considered a new independent potential matching set, we developed a recursive method to deal with the remaining points. If (N-m) is still large, we can compute the convex hulls for 2D, 3D (N-m) point sets and create the potential matching cases for it. As shown in FIG. 3(c; d), we deal with the remaining point sets just like the initial point sets. By recursively repeating the procedure mentioned above until the remaining points number is small enough, we can reduce the potential matching cases to

$$O ( {2}^{r} {\prod }_{r} {m}_{i} {\prod }_{r} {H}_{{n}_{i}}^{{m}_{i}} ) ,$$

where r is the number of layers (recursive calls) of point set splitting. It is easy to tell that the algorithm has no computational benefit when the number of the remaining points is less than 4. Therefore, we can shrink the problem space until (N-m)≦4.

Not only the circuit searching but also the horizon validation can be recursively propagated. Initially, the valid region is set to infinite before we begin the horizon validation computation. After the first level horizon validation, we go to the next layer of circuit searching. Since the focal point should not be changed when we search the circuit in next layer, the common valid region of the next layer can only stay inside the common valid region of the previous layer. We can propagate the common valid region of the first level horizon as the initial valid region to the next layer, which is no longer infinite. During the valid region propagation, the common valid region may be split into several pieces by the edges and triangles. Fortunately, most of the pieces turn out to be invalid very quickly.

Since m≦n, the 2D convex hull is the benchmark for each recursive convex matching. To optimize the computation, we can pre-compute all the layers of 2D convex hull. However, when we delete m points from the 3D point sets dynamically, we have to re-compute the 3D convex hull for the remaining point sets again and compute a new 3D convex hull for next recursive step.

Finally, for each potential point set, we do a calibration computation of the projection matrix. Then we re-project the 3D points into 2D by perspective projection and calculate the residual error (Eq. 1). The points matching case with the smallest residual error is determined to be the correct matching case.

### EXPERIMENT

The ideal projection model has 11 parameters. For each potential correspondence between the 3D and 2D point sets, we compute the projection parameters that optimally project the 3D world points into the 2D image. We use a closed-form calibration method that computes the intrinsic and extrinsic parameters by solving the perspective projection equation.

\vec{X}^{c}=Proj(CP,\vec{X}^{w}) (2)

where Proj( ) is the projection function, Where CP is camera parameters. \vec{X}^{w} and \vec{X}^{c} are corresponding 3D and 2D point sets in 3D and 2D space respectively. Camera parameter CP can be decomposed into the product of the intrinsic parameter matrix and the extrinsic parameter matrix.

CP=A·P (2)

### Where

$$A = s [ \begin{matrix}{f}_{x} & 0.0 & {IC}_{x} \\ 0.0 & {f}_{y} & {IC}_{y} \\ 0.0 & 0.0 & 1.0\end{matrix} ]$$

is the set of intrinsic parameters; s is the scalar; fₓ and f_{y} are the scaled focal lengths and ICₓ, IC_{y} are the projection principle points. The extrinsic parameters are P=[R|T], where R is a 3×3 rotation matrix and T is the translation vector. Given a set of at least 6 pairs of points \vec{X}^{w} and \vec{X}^{c}, we can compute the camera parameters, A and P. After the basic camera parameters are computed, we can re-project the 3D points into 2D plane and compute the residual error [Eq. 1]. The matching case with the smallest residual error is the correct one. Correct camera parameters are also computed in the matching procedure as a by-production.

To show the power of our method, we designed the following simulation procedure.
1. Randomly generate the coordinates for a set of 3D points with uniform distribution.
2. Pick a set of projection parameters.
3. Project the 3D points into the 2D plane.
4. Input the 3D and 2D point sets into the improved convex hull based enumerator.
5. Generate all potential matching cases by the enumerator and input each potential matching case into the calibration computation to compute a set of projection parameters and residual error.
6. Select camera parameters that yield the smallest residual error.

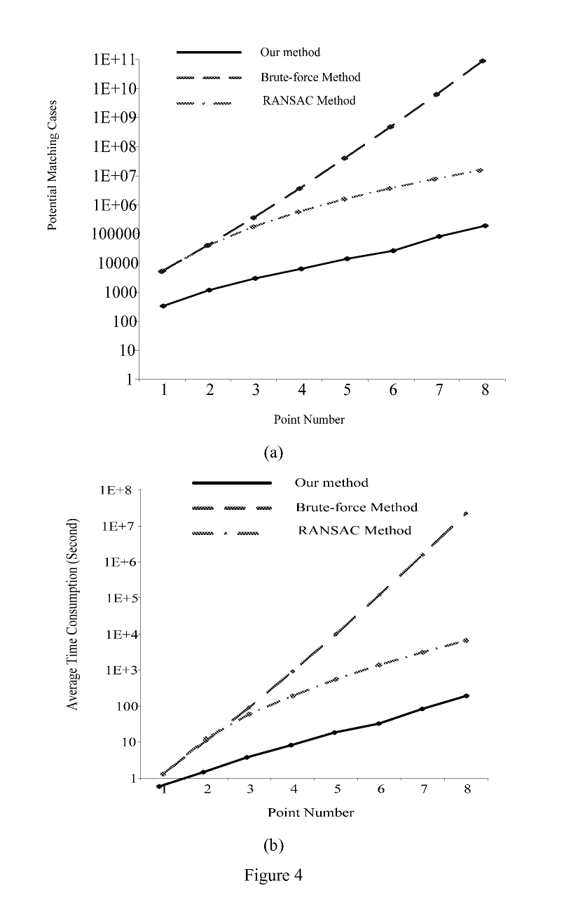

We also retry eight cases with different point numbers for 100 times and the average result is shown in Table 1. From the FIG. 4, we have learned that when the point number is less than 9, the validation computation cost more time than the calibration time for invalid circuits. However, when the point number is increased, most of the circuits are invalidated and some horizons are not compatible with the horizons in the next layer. Therefore, the circuit validation decreases the total computation time dramatically. In case of 14 points, it can decrease the time consumption from 42 minutes by the brute-force method to 3 minutes by our method.

TABLE 1
The Average Results from 100 repeated simulations for each point number
(using Intel Celeron 2.0 GHz)

| | | | | | | | | |
|---|---|---|---|---|---|---|---|---|
| Total Points | 7 | 8 | 9 | 10 | 11 | 12 | 13 | 14 |

Our Method (O(2ⁿ))

| | | | | | | | | |
|---|---|---|---|---|---|---|---|---|
| Potential Cases | 541.3 | 1955 | 5057 | 1.08+E4 | 2.45+E4 | 4.51+E4 | 1.48+E5 | 3.41+E5 |
| Ave Time (Sec) | 0.562 | 1.378 | 3.587 | 7.778 | 17.37 | 30.18 | 77.03 | 177.2 |

$RANSAC ( O ( 7 ! \cdot ( \begin{matrix}7 \\ n\end{matrix} ) ) using 7 points for the initial estimation )$

| | | | | | | | | |
|---|---|---|---|---|---|---|---|---|
| Potential Cases | 5040 | 4.03E+4 | 1.81E+5 | 6.04E+5 | 1.66E+6 | 4.00E+6 | 8.65E+6 | 1.73E+7 |
| Ave Time (Sec) | 1.26 | 11.01 | 50.0 | 151.2 | 415.8 | 998.0 | 2162.16 | 4324.50 |

Brute-force Method (O(N!))

| | | | | | | | | |
|---|---|---|---|---|---|---|---|---|
| Potential Cases | 5040 | 40320 | 362,880 | 3.63E+6 | 3.99E+7 | 4.79E+8 | 6.23E+9 | 8.72E+10 |
| Time (Sec) | 1.26 | 11.01 | 90.72 | 910.21 | 9979.20 | 1.21E+5 | 1.56E+6 | 2.18E+7 |

### APPENDIX

Theorem 1. As shown in FIG. 1(a), given 3D point set S, the face p defined by three 3D points A, C and D. ΔACD is a face of the 3D convex hull (CH(S)) if and only if all other points of the point set S lie on the plane p or to one side of it. □

Theorem 2. As shown in FIG. 1(b), given 2D point set S′, the line segment l defined by two 2D points A′ and C′. (A′C′) is an edge of the 2D convex hull (CH(S′)) if and only if all other points of the point set S′ lie on l or to one side of it. □

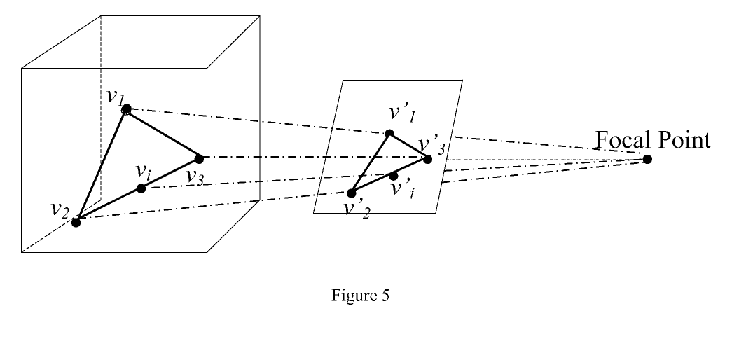

Lemma 1. As shown in FIG. 5, given 3D triangle Δν₁ν₂ν₃, its 2D perspective projection is also a triangle, called Δν′₁ν′₂ν′₃. We also have that all the points interior to the triangle Δν₁ν₂ν₃ are projected into the interior of triangle Δν′₁ν′₂ν′₃. (If the 3D triangle is projected into a 2D plane as a line segment, it can also be considered as a special case of Lemma 1.) □

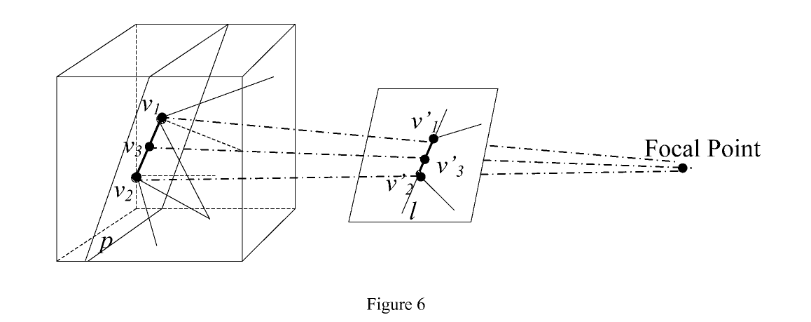

Theorem 3. Given 2D point set S′ [FIG. 6(b)] which is the projection of 3D point set S [FIG. 6(a)], if ν′₁,ν′₂ are adjacent points in the 2D convex hull of S′, then ν₁, ν₂ are also adjacent in the 3D convex hull of S, where ν′₁ and ν′₂ are 2D projections of 3D points ν₁ and ν₂. (This can be proved with Lemma 1 easily.) □

1. A method of finding correspondence between 3D uniform point set and its 2D perspective projection, comprising the steps of: convex hull computation for both 3D and 2D point sets; potential matching cases selection; calibration computation based validation.

2. The method of claim 1, wherein the step of potential matching cases selection comprises the steps of: potential 3D to 2D convex hull matching; horizon computation based validation; recursive potential matching case selection for next layer points.
